(19) United States
(12) Patent Application Publication
(10) Pub. No.: US 2010/0283834 A1
(43) Pub. Date: Nov. 11, 2010

(54) DEVICE FOR 3D IMAGING

(75) Inventor: Ian M. Baker, Hampshire (GB)

Correspondence Address: BUCHANAN, INGERSOLL & ROONEY PC, POST OFFICE BOX 1404, ALEXANDRIA, VA, 22313-1404, US

(73) Assignee: Selex Galileo Limited, Essex (GB)

(21) Appl. No.: 12/811,353

(22) PCT Filed: Feb. 5, 2009
(86) PCT No.: PCT/EP2009/051326

§ 371 Date: Jun. 30, 2010

(30) Foreign Application Priority Data
Feb. 8, 2008 (GB) 0802401.0

(51) Int. Cl. H04N 13/02

(52) U.S. Cl. 348/46; 348/E13.074

(57) ABSTRACT

A 3 dimensional (3D) imaging device is described. The device emits a laser pulse towards a scene. Radiation reflected by the scene includes information relating to the range between objects in the scene. A detector, detects the reflected radiation pulses and outputs signals characteristic of the scene to an imaging device or camera. Two image frames will be produced per radiation pulse, one frame being representative of the ‘close’ object and the second frame being representative of the ‘far’ object. The ratio of these frames may be processed by suitable means to produce a 3D image of the scene.

This invention relates to the field of solid state radiation detection, particularly to Infra Red (IR) imaging. More specifically, but not exclusively the invention relates to a device for 3D active IR imaging.

Active imaging systems, using a near-infrared pulse laser and a fast, gated detector, are typically adopted for most long range IR imaging applications. This concept is often called burst-illumination LIDAR or BIL. One known form of such a solid state detector is based on an array of HgCdTe avalanche photodiodes, and a custom-designed CMOS multiplexer to perform the fast gating and photon signal capture. These hybrid arrays produce sensitivities as low as 10 photons, due largely to very high, almost noise-free avalanche gain in the HgCdTe diodes.

One of the strengths of such laser gated imaging is the segmentation of objects from their background, thereby providing a signal-to-clutter advantage. However, in complex scenes, with camouflage and concealment, a major systems enhancement would be the ability to generate 3D images.

Accordingly, there is provided a device for producing a 3D infrared image of a scene where a radiation pulse is emitted by the device toward the scene, the reflected radiation being detected by a suitable detector, the detector having an integration time, for converting the reflected photons to electrons, and a readout time, to scan the pixels and convert generated voltage signals to digital signals, in which there are two frames generated per integration time, both frames producing an image intensity dependent signal comprising a series of pixels, the pixels in the first frame being multiplied by a range factor dependent on the range of the scene from the laser, such that noise sources are correlated out of the scene thereby providing a 3D image of the scene.

For example, a detector senses range, as well as laser pulse intensity, on a pixel-by-pixel basis, providing depth context for each laser pulse. This creates 3D data, enabling objects to be extracted from background clutter far more effectively. Advantageously, the range information is less affected by excess contrast, coherence and scintillation effects so the images can be much cleaner than conventional 2D BIL images. Furthermore, in airborne applications, especially, it is useful to have 3D information to provide agile, feedback control of the range gating in a dynamic environment.

The invention will now be described by way of example and with reference to the accompanying drawings, in which:

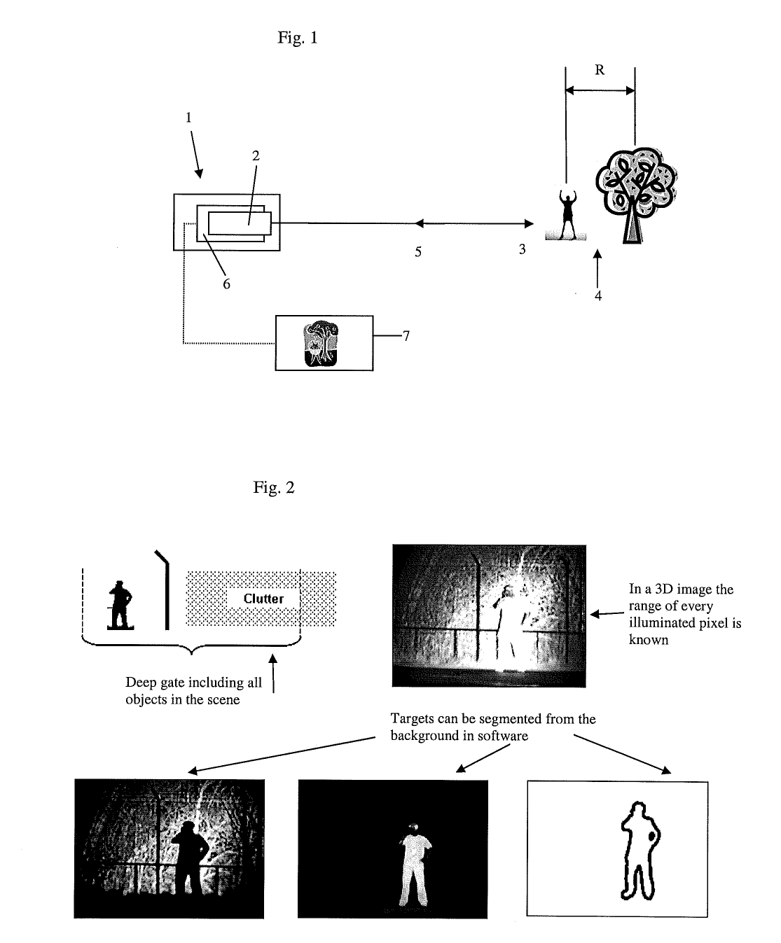

FIG. 1 is a schematic drawing of a device in accordance with one form of the invention, showing a radiation pulse being emitted toward a scene, the radiation being reflected by the scene and detected by a detector located within the device, the device outputting a 3D image representative of the actual scene;

FIG. 2 is a series of images showing the image manipulations possible using 3D data representative of a scene; and

FIG. 1 shows a device 1 in accordance with one form of the invention. The device 1 includes a laser 2 emitting radiation 3 toward a scene 4. The radiation 3 is scanned by the laser 2 across the scene, said scanning having a predetermined readout time T. Radiation reflected by the scene 5 is incident on a detector 6 within the device 1, the detector 6 converting the photons detected into electrons, said conversion having an integration time i. In the case of the 3D detector in accordance with the inventor, two reflected signals are generated per laser pulse emitted by the device 1.

By definition, a 3D imaging detector produces two signals in response to a single laser pulse return. The first is a conventional photon intensity signal, and the second is a signal representative of the range R. To clarify this, a typical application may set up a 10 m deep range gate around a vehicle, say. The detector will provide the depth of each pixel on the vehicle relative to the back of the range gate, so the shape can be determined absolutely. For 3D detectors, some new parameters need to be defined, reflecting the measurement of range. The sensitivity parameter for range or “range accuracy”, so called to prevent confusion with the intensity figure of merit noise-equivalent-photons. Spatial noise in intensity is understood as the incomplete cancellation of non-uniformity by the processing electronics. A similar effect occurs in range, and we call this “range scatter”.

This invention provides for autocorrelation of some of the noise sources. In particular, coherence or scintillation effects in the image are common between the two frames and eliminated in signal processing so that accurate and stable range data can be acquired in the presence of a high degree of image noise. The same correlation also applies to the largest of the electronic noise sources: notably KTC noise (the thermal noise arising from switching a capacitor), so that the range accuracy can be independent of the key multiplexer noise source. The multiplication factor depends on the timing of the laser return pulse with reference to the end of the gate, so for instance, the range information can be gathered over the last 100 ns of the gate period giving 3D information over 15 m of space. The range depth, in this case 100 ns, can be controlled by an applied voltage. Experimental pixel circuits have been assessed at low temperature to establish the noise and sensitivity parameters. Simulation and modelling has then been used to predict the range accuracy and intensity sensitivity (noise equivalent photons). The range accuracy depends on the signal strength in volts, which is in turn controlled by the avalanche gain, so avalanche gain is a useful variable for controlling for range accuracy, as well as the photon sensitivity.

The 3D array produces 2 frames of data from which the photon signal and range signal need to be extracted. At the simplest level a comparison of frame 1 against frame 2 gives a parameter called “range ratio” and this is dependent on the actual range for that pixel. Because of non-idealities in the circuit realisation there are some extra corrections to be made to extract a true range value. Firstly the range value depends on the strength of the return signal so that brighter objects appear closer. Secondly the range is not linearly proportional to the range ratio so some gamma correction is needed. Thirdly the pixel to pixel values of range ratio can be dispersed due to simple variances in the silicon components. Since all of these features depend on silicon properties the aberrations should be stable in time and software correction should be effective. However the post-processing of the image data is essential to make full use of the range and intensity data to produce accurate 3D representations and is a key area in the camera development.

There are a number of ways of realising the analogue multiplication function. Preferably, a technique that is fairly insensitive to the shape of the laser signal return may be used. At first it may seem counter-intuitive that laser pulse delays of less than a nanosecond can be obtained from a laser pulse of 20 ns width but the device responds to the centre of gravity of the laser pulse.

FIG. 2 shows how the outline of a man can be extracted from the deep gate by knowledge of the individual pixel ranges. Also, there may be opportunities for improving identification and automatic target recognition, by presenting an image in depth only, as this has the potential for defeating camouflage and concealment. For man-in-the-loop applications, 3D data can be manipulated to present images with perspective, false distance attenuation, and shadows. This can make distant, flat images appear close and more natural, providing the human cognitive system more chance of interpreting complex scenes. For the human observer the separation of objects and outlines is strongly enhanced by rotating the scene in software, creating a false parallax, and even presenting the scene as a plan view. Finally, for airborne applications in particular, the 3D data can be used for automatic tracking, essentially by holding the target in the centre of the gate.

Specific examples of the component parts of the device 1 will now be described. However, it will be appreciated that these are for example only and any suitable detector, laser or signal processing means capable of performing the functions described may be used.

Frame 1 and frame 2 both contain the intensity signal. Frame 2 is multiplied by a factor that depends on the timing of the laser pulse within the temporal gate. By comparing the two frames the multiplication factor can be extracted and the timing calculated. There are a number of schemes and techniques for performing the multiplication.

The signal (in electrons) can be split into two channels with one channel as a reference (frame 2). The other channel has a charge or current amplifier with a gain that varies through the gate (frame 1). The amplifier can be formed in silicon as a current amplifier and an integrating capacitor, and in this configuration the electron signal from the laser pulse is multiplied as the charges arrive.

The electron signal is converted to a voltage when it is integrated on a capacitor. Another technique is to vary the capacitance so that the voltage signal changes through the gate time. When the voltage signal is converted back to charge and integrated the signal magnitude is made to depend on the timing in the gate.

Another technique is to have an impedance in series with the integration capacitance so that the RC time constant is comparable with the gating time. This gives a frame 1 signal which varies according to the time remaining in the gate.

The signal amplifier could also utilise the avalanche gain in the CMT diode. By applying a varying bias voltage on the CMT diode the avalanche gain and hence the signal magnitude can be made to vary through the gate.

For laser-gated imaging, such as that described above, the detector 1 needs to be about 100× more sensitive than a conventional thermal imaging detector, and to have a response time around 10,000× faster. In one form of the invention, the sensitivity is met by using avalanche gain (up to 150×) in a HgCdTe photodiode, and a fast interface circuit in a CMOS multiplexer. The speed of response is achieved by having pixel-level gating circuits to switch the detector 6 on and off. In operation, the gating circuits are controlled directly by a host computer for the device 1, to obtain accurate image-based range gating. Solid state sensors have near-ideal modulation transfer function (MTF) as a result of the strong optical absorption and limited cross-diffusion of minority carriers, and images from trials have shown characteristic sharpness.

There are two main HgCdTe technologies available for BIL detectors 6, including the 2^{nd} generation loophole processor or 3^{rd} generation processes based on MOVPE, bump bonded hybrids. The detector 6 typically comprises diode arrays, biased at up to 8V to stimulate avalanche multiplication of the laser signal. In HgCdTe at a wavelength of around 4.0 um this process is very effective, largely stemming from the solid state characteristics of the HgCdTe system, which provides a very high electron to hole mobility ratio and nearly ideal cascade-like avalanching. The via-hole technology uses HgCdTe grown by the liquid phase epitaxy process, which is believed to give the lowest material dislocation densities. This is important, to maintain low noise and defect levels in detectors biased to many volts.

Laser-gated imaging, such as that described in this embodiment of the invention, usually employs very short integration times, typically less than a microsecond, and there is not enough time to accumulate leakage current and excess noise. Because of this, the array defect levels and excess noise under high avalanche gain can be remarkably low, and similar to that of standard thermal imaging arrays without avalanche gain. Avalanche gains of up to ×150 are used but for most practical situations a gain of around ×20-×40 is more than adequate. The main drawback of using 4.0 um cut-off HgCdTe is that the best performance is at cryogenic temperatures and a Stirling engine is needed. However, there do not appear to be any disadvantages with the use of engines, particularly in airborne applications, as modern engines and encapsulations are small and consume little power.

Short wave (SW) detectors may be used that have a standardised array size of 320×256 and a pixel size of 24 μm (to meet the Fraunhoffer diffraction conditions in the slow optical systems commonly used in BIL applications). The Focal Plane Array (FPA) is typically integrated into a cryocooler assembly using a small Stirling engine and is fitted with a notch filter for transmission at 1.55 μm. The avalanche gain is made variable in the device, to control the sensitivity and the photon saturation level.

Advantageously, 2D BIL detector and camera legacy technology may be used, whilst upgrading to the 3D functionality. This may include retaining array size of 320×256 and pixel size of 24 um. Also the 2D intensity signal may be maintained at the same sensitivity, i.e. at 10 photons rms, so that the default setting of the 3D detector emulates previous 2D detectors. The retention of existing cryogenics and vacuum packaging may mean placing a power consumption limit of 50 mW on the FPA and a maximum clocking rate of 10 MHz.

Additionally, the laser pulse width is a key consideration due to the high energy pulse lasers of the types used at 1.55 um (e.g. OPO converted Nd_YAG) have an optimum efficiency at pulse widths of circa 20 ns and a further reduction in efficiency to achieve a very narrow pulse is highly undesirable. Therefore a FPA may be used that is not sensitive to the laser pulse width.

As the intensity signal is strongly affected by coherence effects, and there is no correlation between laser pulses, it may be necessary to gather both the range and intensity signal for each laser pulse. For the device there is a need to produce a similar electrical interface to a 2D detector both in terms of signal dynamics and clocking speeds.

A variable “range depth” function may be incorporated so that range information can be acquired over a depth in space determined by the device operator. In this way relatively coarse data may be gathered over a deep scene or higher resolution data gathered over a shallower scene.

The incorporation of analogue circuitry in the pixel to produce both a range and intensity signal is only possible if some radical compaction strategies are used. If 24 μm is adopted as the standard pixel size for the short wavelength family of detectors it would seem that, for more complex pixel circuits, the designer would simply choose a denser CMOS process, in order to obtain a larger number of active devices and interconnects in the pixel. In digital circuits this is true but, when designing analogue circuits, voltage range, noise and uniformity are performance-driving factors. BIL detectors require a high voltage tolerance, and this is not generally compatible with dense CMOS processes. Also, MOSFET noise and threshold voltage uniformity both scale with an approximate inverse square-root law, so some components cannot be shrunk without compromising the noise floor and uniformity of the pixel circuit, and ultimately the camera performance.

The constraints imposed by a small pixel size, and components that cannot be shrunk, would seem to limit the development potential of solid state arrays. Nevertheless, there are strong pressures to develop more complex circuits in the focal plane for multifunctional arrays. The approach adopted in one form of the invention has similarities to an uncommitted gate array in the digital world. In the present case, the pixel components are assembled together in the best compaction geometry, but with uncommitted connections. Tiny switches are then used to connect the components into the required circuit function. At the same time, the metal tracks serving the pixel (there may be up to 10 of them) are also switched, so the function of each track can change radically. This combination of variable stimuli and circuit topology allows the functionality to be determined by a software instruction. This practice, topomorphic design (from topology morphosis), is devised to break the natural design limits of dense pixels. The switches have no significant specification for noise or uniformity, and can be the minimum geometry for the CMOS process, so they usually take up little space. In this way, topomorphic design can be exploited very effectively to create a 3D functionality.

Laser-gated imaging has been shown to be a valuable tool for long range imaging, and the field is growing rapidly as new detectors, lasers, platforms and signal processing techniques are developed. The emergence of 3D detectors, will further augment the recognition, identification and intent for systems in ground based, naval and airborne scenarios. A 3D laser-gated imaging detector based on the above invention has been shown to produce simultaneous intensity and range data.

1. A device for producing a 3D infrared image of a scene where a radiation pulse is emitted by the device toward the scene, the reflected radiation being detected by a suitable detector, the detector having an integration time, for converting the reflected photons to electrons, and a readout time, to scan the pixels and convert generated voltage signals to digital signals, in which there are two frames generated per integration time, both frames producing an image intensity dependent signal comprising a series of pixels, the pixels in the first frame being multiplied by a range factor dependent on the range of the scene from the laser, such that noise sources are correlated out of the scene thereby providing a 3D image of the scene.

2. A device according to claim 1, wherein the detector comprises a diode array and the radiation pulse is laser radiation emitted by a laser having a suitable wavelength for detection by the detector.

3. A device according to claim 1, wherein the laser has a wavelength of 1.55 μm.

4. A device according to claim 3, wherein the radiation source is an Optical Parametric Oscillator (OPO) converted Nd_YAG laser.

5. A device according to claim 1, wherein the detector comprises an array of 320×256 pixels, the pixel size being of the order of 24 μm.

6. A device according to claim 1, wherein the device outputs a signal to a display device capable of displaying the image as a 3D image having false colours representative of the range of aspects of the scene from the location of the device.

7. (canceled)

8. A device according to claim 2, wherein the laser has a wavelength of 1.55 μm.
